(19) United States
(12) Patent Application Publication
(10) Pub. No.: US 2003/0207967 A1
(43) Pub. Date: Nov. 6, 2003

(54) Stabilizers for power coatings

(76) Inventor: Hugh Stephen Laver, Reinach (CH)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 10/380,027

(22) PCT Filed: Oct. 9, 2001
(86) PCT No.: PCT/EP01/11648

(30) Foreign Application Priority Data
Oct. 16, 2000 (EP) 00810951.4

(51) Int. Cl. C08K 5/15; C08K 5/34; C08K 5/49

(52) U.S. Cl. 524/99; 524/116; 524/107

(57) ABSTRACT

A powder coating composition comprising (I) an organic film-forming binder and (II) a sterically hindered amine compound selected, for example, from class (a-1); (a-1) a compound of formula (A-1) in which m₁ is 1, 2 or 4, if m₁ is 1, E₁ is C₁-C₂₅alkyl, if m₁ is 2, E₁ is C₁-C₁₄alkylene, and if m₁ is 4, E₁ is C₄-C₁₀alkanetetratyl.

The present invention relates to powder coating compositions comprising an organic film-forming binder and a specific sterically hindered amine compound as well as to the use of such specific sterically hindered amine compound for reducing the discolouration of heat-curable powder coatings.

Powder coating is a known technology and is described, for example, in “Ullmann's Encyclopedia of Industrial Chemistry, Fifth, Completely Revised Edition, Volume A 18”, pages 438 to 444 (1991). In the powder coating process, a powder is generally fluidized with supply of air, electrostatically charged and applied to an earthed, preferably metallic substrate. The substrate is subsequently heated, in the course of which the adhering powder melts, coalesces and forms a coherent film on the metal surface. Since powder coating requires no solvent, this technology is especially friendly to the environment.

The curing of the powder coating compositions at elevated temperature, especially in a gas oven, is not without difficulties. The nitrogen oxide gases present in the gas oven often cause unwanted discolouration of the coating.

In the prior art, powder coating compositions are stabilized with a mixture of a sterically hindered phenol, for example the octadecyl ester of 3-(3,5-di-tert-butyl-4-hydroxyphenyl)propionic acid, and an organic phosphite, for example tris(2,4-di-tert-butylphenyl) phosphite. With this stabilization, however, when the powder coating composition is cured at elevated temperature, especially in a gas oven, severe unwanted discolouration of the coating is observed. This discolouration can be suppressed somewhat if the sterically hindered phenol is omitted and if stabilization is effected only with an organic phosphite. Stabilization of the powder coating with only an organic phosphite, however, has the disadvantage that the stability of the coating to oxidative attack is greatly reduced.

It is also desirable to stabilize powder coatings against overbaking. Such overbaking can take place, for example, if the conveyor belt in the heated oven remains at a standstill or if components require recoating because of coating defects.

Hindered amines, and among them especially compounds containing 2,2,6,6-tetramethylpiperidyl groups, are known as light stabilizers (hindered amine light stabilizers; HALS).

GB-A-2 267 499 describes solid solutions of tetraalkylpiperidinyl compounds.

GB-A-2 265 377 discloses phosphites and phosphonites with HALS structural elements as stabilizers for powder coatings.

EP-A-816 442 describes the use of a stabilizer mixture which contains among other things a sterically hindered amine compound and an organic phosphite or phosphonite in powder coating compositions.

The known stabilizers do not in every respect satisfy the stringent requirements that a stabilizer or a mixture of stabilizers should meet, especially in terms of the discolouration of heat-curable powder coating compositions, especially those curable in gas ovens.

The present invention therefore provides powder coating compositions comprising

(I) an organic film-forming binder and

(II) a sterically hindered amine compound selected from the group consisting of the classes (a-1) to (a-11) and (b-1) to (b-4);

(a-1) A Compound of the Formula (A-1)

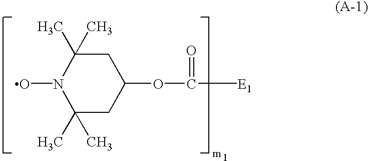

in which

m₁ is 1, 2 or 4,

if m₁ is 1, E₁ is C₁-C₂₅alkyl,

if m₁ is 2, E₁ is C₁-C₁₄alkylene, and

if m₁ is 4, E₁ is C₄-C₁₀alkanetetrayl;

(a-2) A Compound of the Formula (A-2)

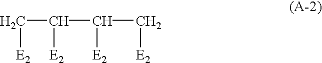

in which

two of the radicals E₂ are —COO—(C₁-C₂₀alkyl), and

two of the radicals E₂ are a group of the formula (a-I);

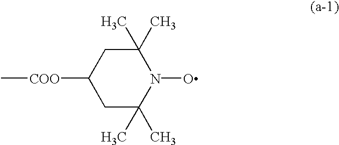

(a-3) A Compound of the Formula (A-3)

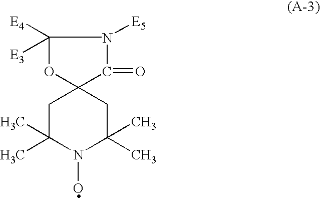

in which

E₃ and E₄ together form C₂-C₁₄alkylene,

E₅ is hydrogen or a group -Z₁-COO-Z₂,

Z₁ is C₂-C₁₄alkylene, and

Z₂ is C₁-C₂₄alkyl;

(a-4) A Compound of the Formula (A-4)

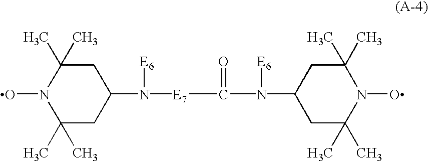

wherein

the radicals E₆ independently of one another are hydrogen or C₁-C₁₂alkyl, and

E₇ is C₁-C₁₀alkylene or C₃-C₁₀alkylidene;

(a-5) The Compound of the Formula (A-5)

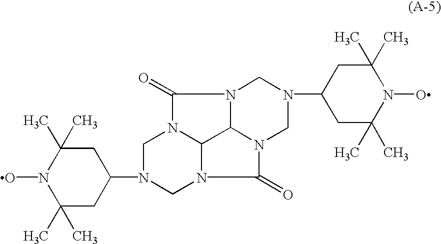

(a-6) A Compound of the Formula (A-6)

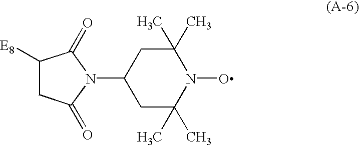

in which

E₈ is C₁-C₂₄alkyl;

(a-7) The Compound of the Formula (A-7)

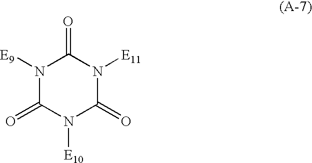

in which

E₉, E₁₀ and E₁₁ are a group of the formula (a-II);

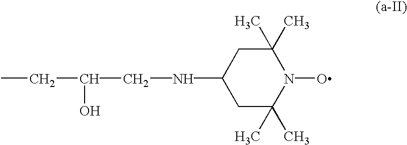

(a-8) A Compound of the Formula (A-8)

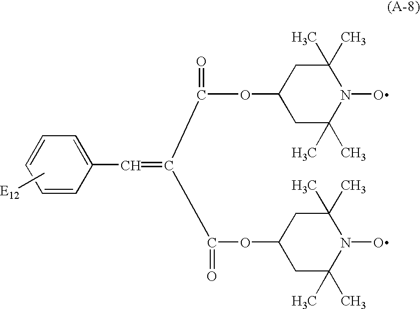

wherein

E₁₂ is hydrogen, C₁-C₁₂alkyl or C₁-C₁₂alkoxy;

(a-9) A Compound of the Formula (A-9)

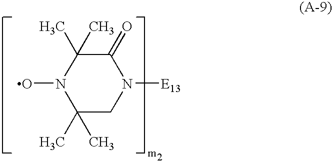

wherein

m₂ is 1 or 2, and

when m₂ is 1, E₁₃ is a group

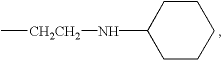

, and

when m₂ is 2, E₁₃ is C₂-C₂₂alkylene; and

(a-10) A Compound of the Formula (A-10)

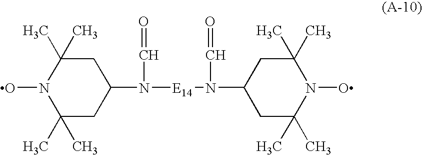

wherein

E₁₄ is C₂-C₂₂alkylene, C₅-C₇cycloalkylene, C₁-C₄alkylenedi(C₅-C₇cycloalkylene), phenylene or phenylenedi(C₁-C₄alkylene);

(a-11) The Compound of the Formula (A-11);

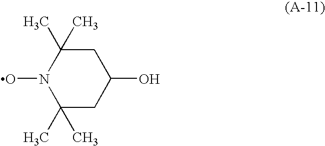

(b-1) A Compound of the Formula (B-1)

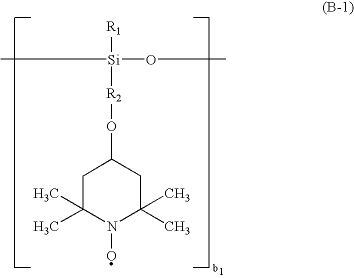

in which

R₁ is C₁-C₁₀alkyl, C₅-C₁₂cycloalkyl, C₁-C₄alkyl-substituted C₅-C₁₂cycloalkyl, phenyl or

C₁-C₁₀alkyl-substituted phenyl,

R₂ is C₃-C₁₀alkylene, and

b₁ is a number from 2 to 50;

(b-2) A Compound of the Formula (B-2)

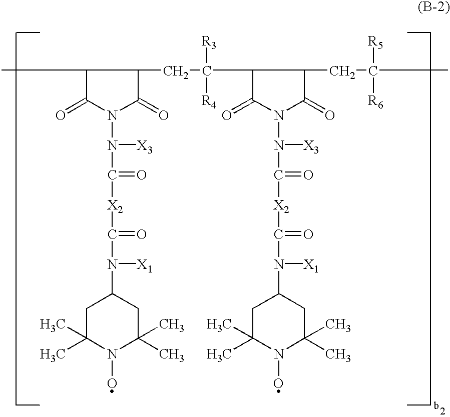

in which

X₁ and X₃ independently of one another are hydrogen, C₁-C₈alkyl, C₅-C₁₂cycloalkyl, phenyl, C₇-C₉phenylalkyl or a group of the formula (b-I),

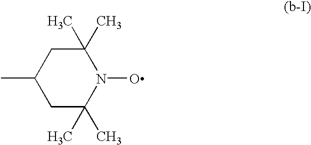

X₂ is a direct bond or C₁-C₄alkylene,

R₃, R₄, R₅ and R₆ independently of one another are hydrogen, C₁-C₃₀alkyl, C₅-C₁₂cycloalkyl or phenyl, and

b₂ is a number from 1 to 50;

(b-3) A Compound of the Formula (B-3)

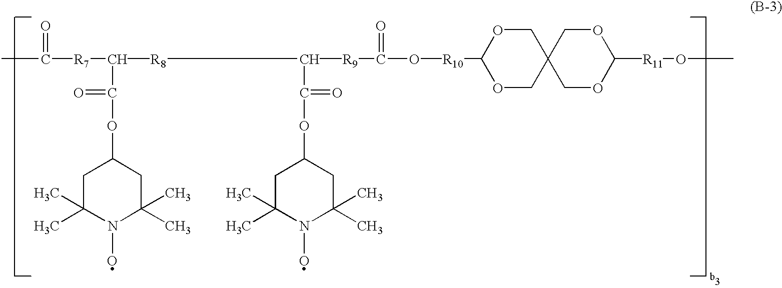

in which

R₇, R₈, R₉, R₁₀ and R₁₁ independently of one another are a direct bond or

C₁-C₁₀alkylene, and

b₃ is a number from 1 to 50;

(b-4) A Compound of the Formula (B-4)

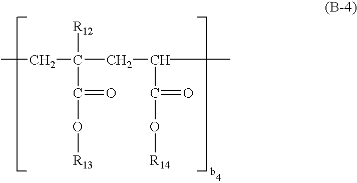

wherein b₄ is a number from 2 to 50,

R₁₂ is hydrogen or C₁-C₄alkyl,

the radicals R₁₃ and R₁₄ independently of one another are C₁-C₄alkyl or a group of the formula (b-I),

with the proviso that at least 50% of the radicals R₁₄ are a group of the formula (b-I).

According to one preferred embodiment of the present invention the variable m₁ is different from 2.

Powder coating compositions of interest are those in which the powder coating composition is one which can be cured by heat, especially in gas ovens.

The term gas ovens refers to ovens fed by burning hydrocarbons such as, for example, methane, propane, butane, coal gas, carbon monoxide, hydrogen or oils. The combustion of the gases or oxidation of the gases with air gives rise, together with the nitrogen present in the air, to the oxides of nitrogen that are undesirable for the curing of the powder coating composition.

The present invention therefore also provides a method of curing powder coating compositions containing the components (I) and (II) as defined above, which comprises curing in a gas oven wherein the powder coating composition is in contact with oxides of nitrogen originating from combustion gases.

Examples of alkyl having up to 30 carbon atoms are methyl, ethyl, propyl, isopropyl, n-butyl, sec-butyl, isobutyl, tert-butyl, 2-ethylbutyl, n-pentyl, isopentyl, 1-methylpentyl, 1,3-dimethyl-butyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl, docosyl and triacontyl.

Examples of alkoxy having up to 12 carbon atoms are methoxy, ethoxy, propoxy, isopropoxy, butoxy, isobutoxy, pentoxy, isopentoxy, hexoxy, heptoxy, octoxy, decyloxy and dodecyloxy. E₁₂ is preferably C₁-C₄alkoxy.

Examples of C₅-C₁₂cycloalkyl are cyclopentyl, cyclohexyl, cycloheptyl, cyclooctyl and cyclododecyl. C₅-C₈Cycloalkyl, especially cyclohexyl, is preferred.

C₁-C₄Alkyl-substituted C₅-C₁₂cycloalkyl is for example methylcyclohexyl or dimethylcyclohexyl.

C₁-C₁₀alkyl-substituted phenyl is for example methylphenyl, dimethylphenyl, trimethylphenyl, tert-butylphenyl or 3,5-di-tert-butylphenyl.

Examples of C₇-C₉phenylalkyl are benzyl and phenylethyl.

Examples of alkylene having up to 22 carbon atoms are methylene, ethylene, propylene, trimethylene, tetramethylene, pentamethylene, 2,2-dimethyltrimethylene, hexamethylene, trimethylhexamethylene, octamethylene and decamethylene.

An example of C₃-C₁₀alkylidene is the group

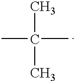

An example of C₄-C₁₀alkanetetrayl is 1,2,3,4-butanetetrayl.

An example of C₅-C₇cycloalkylene is cyclohexylene.

An example of C₁-C₄alkylenedi(C₅-C₇cycloalkylene) is methylenedicyclohexylene.

An example of phenylenedi(C₁-C₄alkylene) is methylene-phenylene-methylene or ethylene-phenylene-ethylene.

b₁ and b₄ are preferably a number from 2 to 25, in particular 2 to 20.

b₂ and b₃ are preferably a number from 1 to 25, in particluar 1 to 20.

Preference is given to powder coating compositions wherein

m₁ is 1, 2 or 4,

if m₁ is 1, E₁ is C₁₂-C₂₀alkyl,

if m₁ is 2, E₁ is C₂-C₁₀alkylene, and

if m₁ is 4, E₁ is C₄-C₈alkanetetrayl;

two of the radicals E₂ are —COO—(C₁₀-C₁₅alkyl), and

two of the radicals E₂ are a group of the formula (a-I);

E₃ and E₄ together form C₉-C₁₃alkylene,

E₅ is hydrogen or a group -Z₁-COO-Z₂,

Z₁ is C₂-C₆alkylene, and

Z₂ is C₁₀-C₁₆alkyl;

E₆ is hydrogen, and

E₇ is C₂-C₆alkylene or C₃-C₅alkylidene;

E₈ is C₁₀-C₁₄alkyl;

E₁₂ is C₁-C₄alkoxy;

m₂ is 1 or 2,

when m₂ is 1, E₁₃ is a group

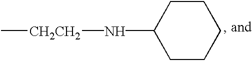

and

when m₂ is 2, E₁₃ is C₂-C₆alkylene;

E₁₄ is C₂-C₈alkylene;

R₁ is C₁-C₄alkyl,

R₂ is C₃-C₆alkylene, and

b₁ is a number from 2 to 25;

X₁ and X₃ independently of one another are hydrogen or C₁-C₄alkyl,

X₂ is a direct bond,

R₃ and R₅ are hydrogen or C₁-C₄alkyl,

R₄ and R₆ are C₁-C₂₅alkyl,

b₂ is a number from 1 to 25;

R₇, R8, R₉, R₁₀ and R₁₁ independently of one another are a direct bond or C₁-C₄alkylene, and

b₃ is a number from 1 to 25;

b₄ is a number from 2 to 25,

R₁₂ and R₁₃ independently of one another are C₁-C₄alkyl, and

R₁₄ is C₁-C₄alkyl or a group of the formula (b-I) with the proviso that at least 50% of the radicals R₁₄ are a group of the formula (b-I).

Preference is also given to a powder coating composition wherein the sterically hindered amine compound of component (II) is a compound of the formula (A-1-a), (A-1-b), (A-1-c), (A-2-a), (A-3-a), (A-3-b), (A-4-a), (A-4-b), (A-5), (A-6-a), (A-7), (A-8-a), (A-9-a ), (A-9-b), (A-10-a), (A-11), (B-1-a), (B-2-a), (B-3-a) or (B-4-a);

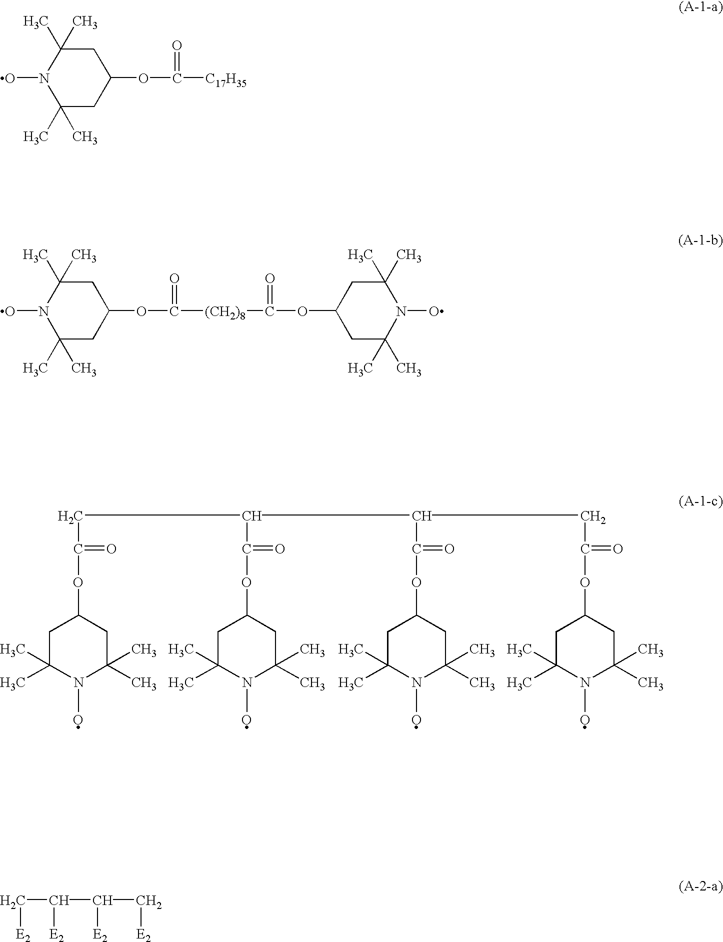

in which two of the radicals E₂ are —COO—C₁₃H₂₇ and two of the radicals E₂ are

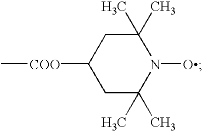

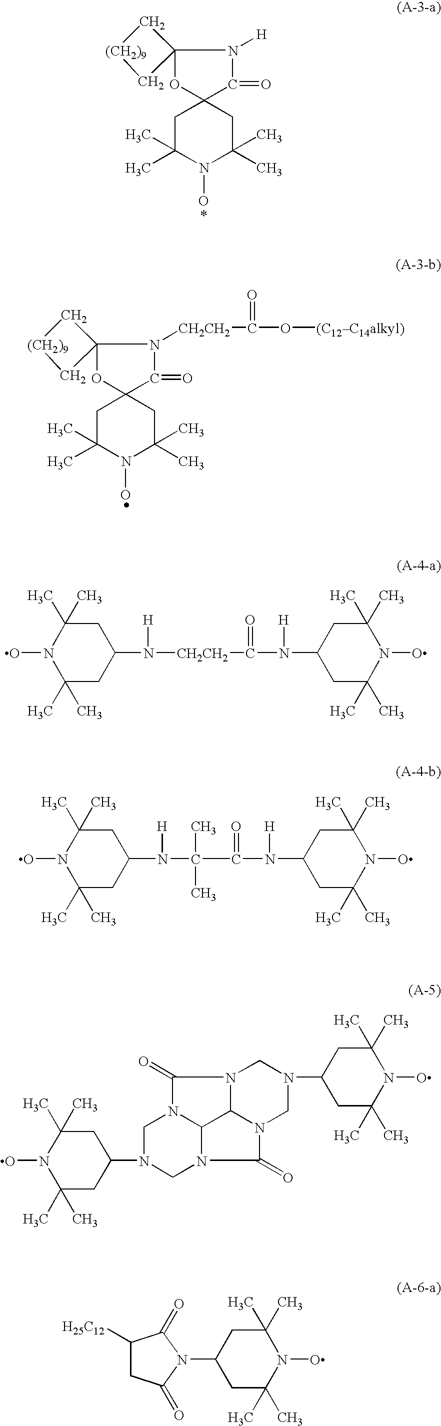

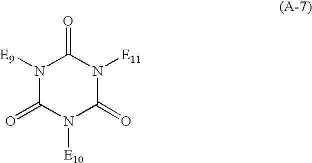

in which E₉, E₁₀ and E₁₁, independently of one another are a group of the formula (a-II)

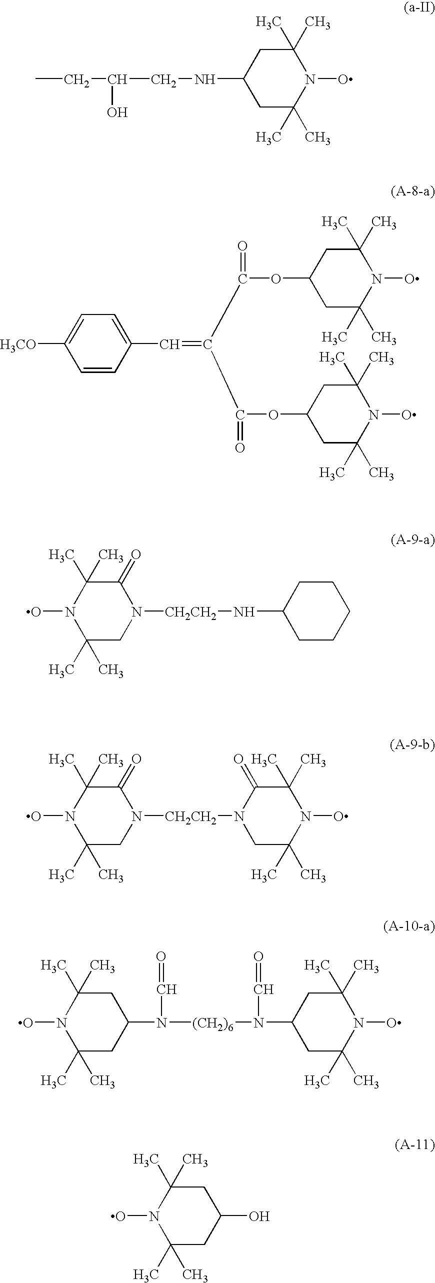

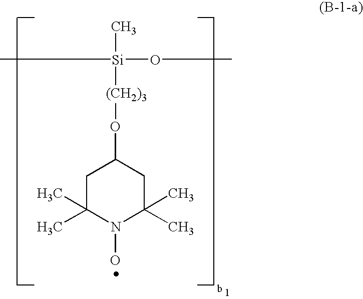

wherein b₁ is a number from 2 to 20;

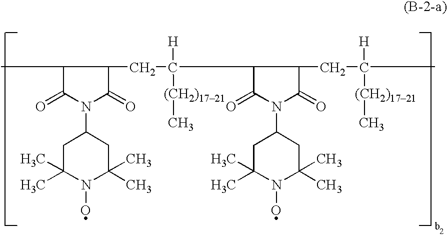

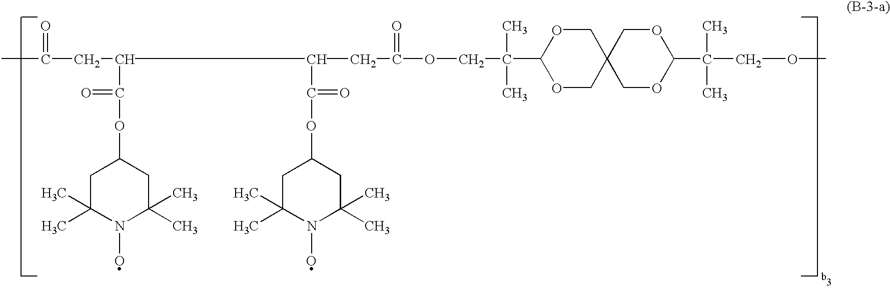

wherein b₃ is a number from 1 to 20;

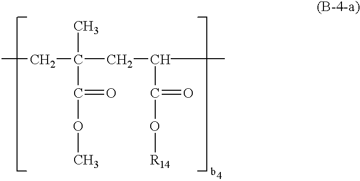

wherein b₄ is a number from 2 to 20, and at least 50% of the radicals R₁₄ are a group of the formula (b-I)

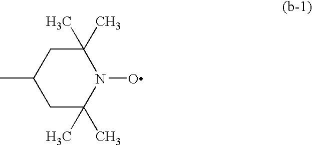

and the remaining radicals R₁₄ are ethyl.

A powder coating composition wherein the sterically hindered amine compound of component (II) is selected from the group consisting of the classes (a-1) to (a-4), (a-6) to (a-10), (b-1), (b-3) and (b-4) is further preferred.

Particular preference is given to a powder coating composition wherein the sterically hindered amine compound of component (II) is selected from the group consisting of the classes (a-1), (a-2) and (a-10).

More preferred is a powder coating composition wherein the sterically hindered amine compound of component (II) is selected from the group consisting of the classes (a-1) and (a-2).

Most preferred is a powder coating composition in which the sterically hindered amine compound of component (II) is a compound of the formula (A-1-a) or (A-1-b).

According to a preferred embodiment of the present invention the powder coating composition contains as further component (Ill) an organic phosphite or an organic phosphonite.

The component (III) is in particular a compound of the formula (1), (2), (3), (4), (5), (6) or (7);

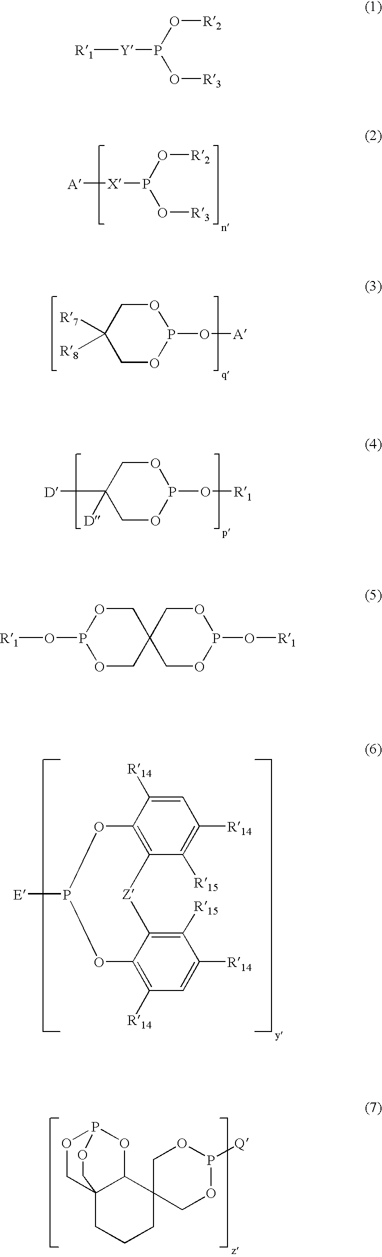

in which the indices are integers and

n′ is 2, 3 or 4; p′ is 1 or 2; q′ is 2 or 3; r′ is 4 to 12; y′ is 1, 2 or 3; and z′ is 1 to 6;

A′, if n′ is 2, is C₂-C₁₈alkylene; C₂-C₁₂alkylene interrupted by oxygen, sulfur or —NR′₄—; a radical of the formula

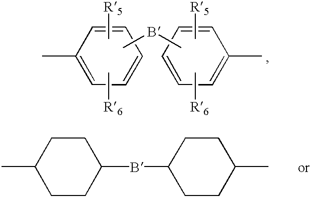

phenylene;

A′, if n′ is 3, is a radical of the formula —C_{r′}H_{2r′-1}—;

A′, if n′ is 4, is

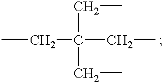

A″ has the meaning of A′ if n′ is 2;

B′ is a direct bond, —CH₂—, —CHR′₄—, —CR′₁R′₄—, sulfur, C₅-C₇cycloalkylidene or cyclohexylidene which is substituted by 1 to 4 C₁-C₄alkyl radicals in position 3, 4 and/or 5;

D′, if p′ is 1, is C₁-C₄alkyl and, if p′ is 2, is —CH₂OCH₂—;

D″, if p′ is 1, is C₁-C₄alkyl;

E′, if y′ is 1, is C₁-C₁₈alkyl, —OR′₁ or halogen;

E′, if y is 2, is —O-A″-O—,

E′, if y is 3, is a radical of the formula R′₄C(CH₂O—)₃ or N(CH₂CH₂O—)₃;

Q′ is the radical of an at least z′-valent alcohol or phenol, this radical being attached via the oxygen atom to the phosphorus atom; R′₁, R′₂ and R′₃ independently of one another are C₁-C₁₈alkyl which is unsubstituted or substituted by halogen, —COOR′₄, —CN or —CONR′₄R′₄; C₂-C₁₈alkyl interrupted by oxygen, sulfur or —NR′₄—; C₇-C₉phenylalkyl; C₅-C₁₂cycloalkyl, phenyl or naphthyl; phenyl or naphthyl substituted by halogen, 1 to 3 alkyl radicals or alkoxy radicals having a total of 1 to 18 carbon atoms or by C₇-C₉phenylalkyl; or a radical of the formula

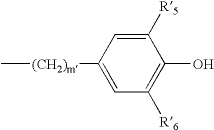

in which m′ is an integer from the range 3 to 6;

R′₄ is hydrogen, C₁-C₁₈alkyl, C₅-C₁₂cycloalkyl or C₇-C₉phenylalkyl,

R′₅ and R′₆ independently of one another are hydrogen, C₁-C₈alkyl or C₅-C₆cycloalkyl,

R′₇ and R′₈, if q′ is 2, independently of one another are C₁-C₄alkyl or together are a 2,3-dehydropentamethylene radical; and

R′₇ and R′₈, if q′ is 3, are methyl;

R′₁₄ is hydrogen, C₁-C₉alkyl or cyclohexyl,

R′₁₅ is hydrogen or methyl, and, if a plurality of radicals R′₁₄ and R′₁₅ are present, these radicals are identical or different,

X′ and Y′ are each a direct bond or oxygen,

Z′ is a direct bond, methylene, —C(R′₁₆)₂— or sulfur, and

R′₁₆ is C₁-C₈alkyl.

Of particular interest are powder coating compositions comprising as component (III) a phosphite or phosphonite of the formula (1), (2), (5) or (6) in which

n′ is the number 2 and y′ is the number 1, 2 or 3;

A′ is C₂-C₁₈alkylene, p-phenylene or p-biphenylene,

E′, if y′ is 1, is C₁-C₁₈alkyl, —OR′₁ or fluorine;

E′, if y′ is 2, is p-biphenylene,

E′, if y′ is 3, is N(CH₂CH₂O—)₃,

R′₁, R′₂ and R′₃ independently of one another are C₁-C₁₈alkyl, C₇-C₉phenylalkyl, cyclohexyl, phenyl or phenyl substituted by 1 to 3 alkyl radicals having a total of 1 to 18 carbon atoms;

R′₁₄ is hydrogen or C₁-C₉alkyl,

R′₁₅ is hydrogen or methyl;

X′ is a direct bond,

Y′ is oxygen,

Z′ is a direct bond or —CH(R′₁₆)—, and

R′₁₆ is C₁-C₄alkyl.

Likewise of interest are powder coating compositions comprising as component (III) a phosphite or phosphonite of the formula (1), (2), (5) or (6) in which

n′ is the number 2 and y′ is the number 1 or 3;

A′ is p-biphenylene,

E′, if y′ is 1, is C₁-C₁₈alkoxy or fluorine,

E′, if y′ is 3, is N(CH₂CH₂O—)₃,

R′₁, R′₂ and R′₃ independently of one another are C₁-C₁₈alkyl, or phenyl substituted by 2 or 3 alkyl radicals having a total of 2 to 12 carbon atoms;

R′₁₄ is methyl or tert-butyl;

R′₁₅ is hydrogen;

X′ is a direct bond;

Y′ is oxygen; and

Z′ is a direct bond, methylene or —CH(CH₃)—.

Particular preference is given to powder coating compositions comprising as component (III) a phosphite or phosphonite of the formula (1), (2) or (6).

Special preference is given to powder coating compositions comprising as component (III) at least one compound of the formula (III-1)

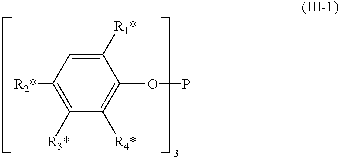

in which R₁* and R₂* independently of one another are hydrogen, C₁-C₈alkyl, cyclohexyl or phenyl, and R₃* and R₄* independently of one another are hydrogen or C₁-C₄alkyl.

The following compounds are examples of phosphites and phosphonites which are particularly suitable as component (III) in the powder coating compositions according to the present invention.

Triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite (Irgafos® 168, Ciba Specialty Chemicals), diisodecyl pentaerythritol diphosphite, bis(2,4-di-tert-butylphenyl) pentaerythritol diphosphite (formula D), bis(2,6-di-tert-butyl-4-methylphenyl) pentaerythritol diphosphite (formula E), bisisodecyloxypentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis(2,4-di-tert-butylphenyl) 4,4′-biphenylenediphosphonite (Irgafos® P-EPQ, Ciba Specialty Chemicals, formula H), 6-isooctyloxy-2,4,8,10-tetra-tert-butyl-12H-dibenzo[d,g]-1,3,2-dioxaphosphocin (formula C), 6-fluoro-2,4,8,10-tetra-tert-butyl-12-methyldibenzo[d,g]-1,3,2-dioxaphosphocin (formula A), bis(2,4-di-tert-butyl-6-methylphenyl) methyl phosphite, bis(2,4-di-tert-butyl-6-methylphenyl) ethyl phosphite (formula G), Ultranox® 641 [GE Chemicals, formula (I)], Doverphos® S9228 [Dover Chemicals, formula (K)] or Mark®HP10 [Adeka Argus, formula (L)].

The following phosphites are used with particular preference:

tris(2,4-di-tert-butylphenyl) phosphite (Irgafos® 168, Ciba Specialty Chemicals), tris(nonyl-phenyl) phosphite,

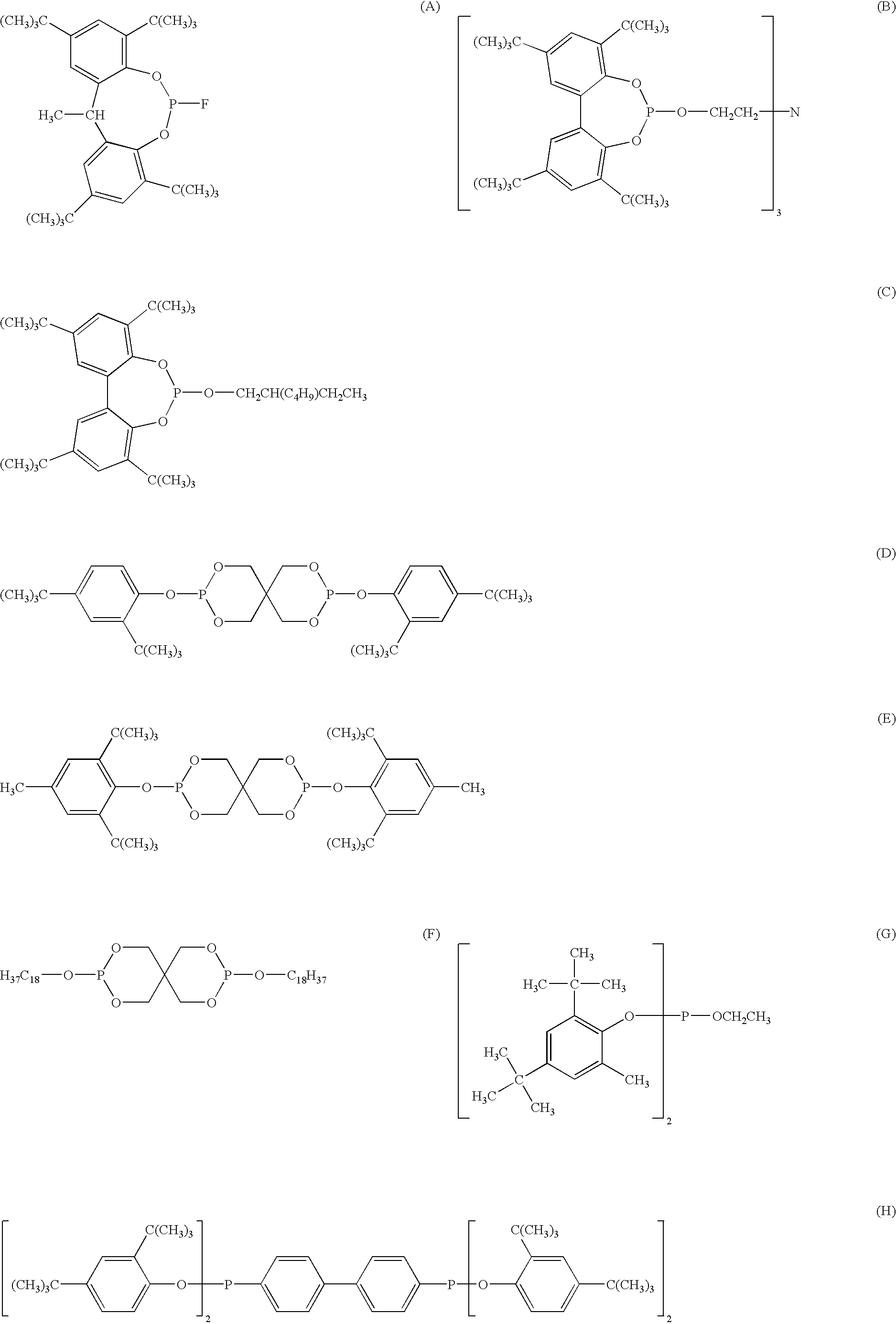

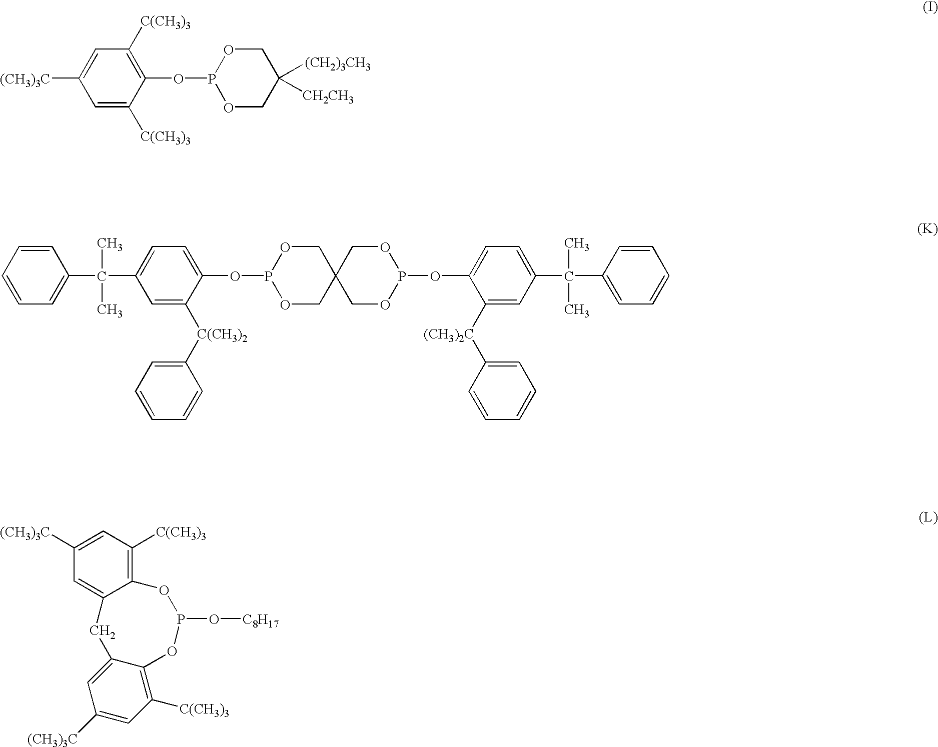

Very particular preference is given to tris(2,4-di-tert-butylphenyl) phoshite [Irgafos® 168, Ciba Specialty Chemicals], bis(2,4-di-tert-butyl-6-methylphenyl) ethyl phosphite [Irgafos® 38, Ciba Specialty Chemicals, formula (G)], Ultranox® 626 [GE Chemicals, formula (D)], tetrakis(2,4-di-tert-butylphenyl) 4,4′-biphenylenediphosphonite [Irgafos®P-EP-Q, Ciba Specialty Chemicals, formula (H)], Ultranox® 641 [GE Chemicals, formula (I)], Doverphos® S9228 [Dover Chemicals, formula (K)] or Mark®HP10 [Adeka Argus, formula (L)].

The compound of the formula (D) [Ultranox® 626, GE Chemicals] or (H) [Irgafos®P-EP-Q, Ciba Specialty Chemicals] is especially preferred as component (III) in the powder coating compositions according to the present invention.

Of particular interest are powder coating compositions comprising as component (III) a compound from the group of the organic phosphites or phosphonites having a melting point of 40-150° C., in particular 60-120° C., e.g. 70-110° C.

The above mentioned sterically hindered amine compounds of component (II) and organic phosphites and phosphonites of component (III) are known compounds; many of them are commercially available.

The sterically hindered amine compounds of component (II) may be prepared e.g. from the corresponding commercially available products which contain groups of the formula

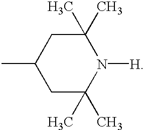

When these hindered amine groups are treated with aqueous hydroperoxide in the presence of a peroxide decomposing catalyst in an inert organic solvent (for example analogously to the method described in U.S. Pat. No. 4,691,015), the reaction product obtained in a relatively short time is the corresponding N-oxyl derivative with groups of the formula

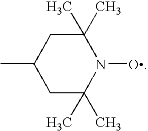

This derivative is highly colored and can be isolated per se. Examples of the hindered amine starting materials are the commercially available products DASTIB 845 (RTM), TINUVIN 770 (RTM), ADK STAB LA 57 (RTM), ADK STAB LA 67 (RTM), HOSTAVIN N 20 (RTM), HOSTAVIN N 24 (RTM), DIACETAM 5 (RTM), SUMISORB TM 61 (RTM), UVINUL 4049 (RTM), CYASORB UV 3581 (RTM), GOODRITE 3110×128 (RTM), GOODRITE UV 3034 (RTM), UVINUL 4050 H (RTM), UVASIL 299 (RTM), UVINUL 5050 H (RTM), ADK STAB LA 68 (RTM) and FERRO AM 806 (RTM).

The preparation of the hindered amine starting materials is for example described in U.S. Pat. No. 3,640,928, U.S. Pat. No. 4,110,306, U.S. Pat. No. 4,619,958, U.S. Pat. No. 4,110,334, U.S. 4,689,416, U.S. Pat. No. 768,175 (Derwent 88-138,751/20), U.S. Pat. No. 5,049,604, U.S. Pat. No. 4,769,457, U.S. Pat. No. 4,356,307, U.S. Pat. No. 5,182,390, U.S. Pat. No. 5,705,545, U.S. Pat. No. 4,547,538, U.S. Pat. No. 4,292,240, U.S. Pat. No. 4,976,889, U.S. Pat. No. 5,051,458, U.S. Pat. No. 5,710,228, U.S. Pat. No. 4,529,760 and EP-A-1,803.

It is particularly surprising to find that the highly colored nitroxyl compounds can be used to prevent discoloration in powder coating on curing.

The term “powder coating compositions” or “powder coatings” is understood as meaning the definition as is described in “Ullmann's Encyclopedia of Industrial Chemistry, 5th, Completely Revised Edition, Vol. A 18”, pages 438 to 444 (1991) under section 3.4. By powder coatings there are meant thermoplastic or stovable, crosslinkable polymers which are applied in powder form to predominantly metallic substrates. The manner in which the powder is brought into contact with the workpiece to be coated characterizes the various application techniques, for example electrostatic powder spraying with corona or triboelectric pistols, electrostatic fluidized-bed sintering or by using magnetic brush technology. Preferred organic film-forming binders for the powder coating compositions according to the present invention are stoving systems based on, for example, epoxy resins, polyester-hydroxyalkylamides, polyester-glycolurils, epoxy-polyester resins, polyester-triglycidyl isocyanurates, hydroxy-functional polyester-blocked polyisocyanates, hydroxy-functional polyester-uretdiones, acrylate resins with hardener or mixtures of such resins. Also of interest are film-forming binders having thermoplastic properties, for example polyethylene, polypropylene, polyamides, polyvinyl chlorides, polyvinylidene dichloride or polyvinylidene difluoride.

Polyesters are generally hydroxy- or carboxy-functional and are usually prepared by condensation of diols and dicarboxylic acids. The addition of polyols and/or polyacids produces branched polyesters which then, on stoving in the presence of crosslinkers, give rise to network structures which impart to the coating the desired physical properties, such as scratch resistance, impact strength and flexural strength. Instead of multifunctional acids it is also possible to use anhydrides or acid chlorides, for example maleic anhydride, itaconic anhydride, phthalic anhydride, terephthalic anhydride, hexahydroterephthalic anhydride, trimellitic anhydride, pyromellitic dianhydride, succinic anhydride, etc. It is also possible to use simple esters, for example dimethyl terephthalate, polymerization proceeding by transesterification with elimination of the volatile alcohol. Likewise practicable is preparation by a combination of transesterification and condensation. Furthermore, polyesters can be prepared by polycondensation of hydroxycarboxylic acids, for example 12-hydroxystearic acid and hydroxypivalic acid, or the corresponding lactones, for example ε-caprolactone. Examples of dicarboxylic acids and polyacids include terephthalic acid, isophthalic acid, adipic acid, azelaic acid, sebacic acid, 1,12-dodecanedioic acid, pyromellitic acid, 3,6-dichlorophthalic acid, succinic acid, 1,3-cyclohexanedicarboxylic acid and 1,4-cyclohexanedicarboxylic acid. Examples of diols and polyols include ethylene glycol, propylene glycol, glycerol, hexanetriol, hexane-2,5-diol, hexane-1,6-diol, pentaerythritol, sorbitol, neopentylglycol, trimethylolethane, trimethylolpropane, tris-1,4-cyclohexanedimethanol, trimethylpentanediol, 2,2-diethyl-1,3-propanediol, 2-methyl-2-butyl-1,3-propanediol, Esterdiol 204 (ester of hydroxypivalic acid and neopentylglycol), hydrogenated bisphenol A, bisphenol A, hydroxypivalic acid, hydroxypivalate esters, 2-butyl-2-ethyl-1,3-propanediol, 1,4-butanediol, 2-butene-1,4-diol, 2-butyne-1,4-diol or 2-methyl-1,3-propanediol.

Suitable crosslinking agents for carboxy-functional polyesters are epoxy compounds, for example Novolac®-epoxy resins, diglycidyl ethers of bisphenol A, hydrogenated bisphenol A and bisphenol A modified by reaction with, for example, aliphatic dicarboxylic acids. Also suitable are reactive epoxy compounds, such as triglycidyltriazolidine-3,5-dione, the glycidyl esters of polyacids, for example diglycidyl terephthalate and diglycidyl hexahydroterephthalate, hydantoin epoxides (U.S. Pat. No. 4,402,983) and, very particularly, triglycidyl isocyanurate and aliphatic polyepoxy compounds such as, for example, Araldit® PT910 (Ciba Specialty Chemicals) and also epoxidized polyunsaturated fatty acid esters such as, for example, Uranox® (DSM). Other crosslinking agents for carboxy-functional polyesters are β-hydroxy-alkylamides (see U.S. Pat. No. 4,076,917), for example the primarily tetrafunctional β-hydroxyalkyl-amide derivative of adipic acid (Primid® XL552 and Primid® QM 1260 from Rohm & Haas). Derivatives of melamine, benzoguanimine and glycoluril which are alkylated with low molecular mass alcohols have also been found to be suitable. Examples are tetramethylmethoxyglycoluril (Powderlink® 1174 from American Cyanamid). Other known crosslinking agents are bis- and trisoxazolidines, for example 1,4-bisoxazolidinobenzene.

Recent substances are carboxy-functional polyesters which include chemically bonded epoxy groups and as a consequence are able to crosslink with themselves (Molhoek et al., 22nd Fatipec Congress, 15.-19.5.95, Budapest, Vol.1, 119-132).

In all systems in which an epoxy group or a glycidyl radical reacts with a carboxyl group or with an anhydride in a crosslinking reaction, catalysts can be employed. Examples are amines or metal compounds, for example aluminium acetylacetonate or tin octoate.

As crosslinking agents for hydroxy-functional polyesters the polyisocyanate crosslinkers are of particular importance. In order to prevent premature crosslinking owing to the high reactivity of isocyanates and in order to obtain good levelling of the melted powder, the polyisocyanates are blocked (internally as a uretdione or as an adduct with a blocking agent). Blocking agents most frequently employed are caprolactam, methyl ethyl ketoxime or butanone oxime. Other suitable blocking agents for isocyanates are described in the publications by G. B. Guise, G. N. Freeland and G. C. Smith, J. Applied Polymer Science, 23, 353 (1979) and of M. Bock and H. -U. Maier-Westhues in “Progress in Product Development for Powder Coating Technology, XIXth Int. Conf. on Organic Coatings, Science and Technol., Athens, Jul. 12-16, 1993.” Examples of blocked and unblocked polyisocyanates include 2-methylpentane 1,5-diisocyanate, 2-ethylbutane 1,4-diisocyanate, 3(4)-isocyanatomethyl-1-methylcyclohexyl isocyanate, 3-isocyanatomethyl-3,5,5-trimethylcyclohexane diisocyanate, tris(isocyanatomethyl)benzene, 4,4′-diisocyanatodicyclohexylmethane, 1,4-bis(isocyanatomethyl)cyclohexane, m-tetramethylxylene diisocyanate, p-tetramethylxylene diisocyanate and, in particular, isophorone diisocyanate. For reaction of the unblocked diisocyante it is common to add a metallic catalyst, for example tin octoate, dibutyltin oxide or dibutyltin dilaurate, to the polyisocyanate formulation.

Further suitable crosslinking agents for hydroxy-functional polyesters are anhydrides, for example trimellitic anhydride and its reaction products with diols and diamines. Further examples of such crosslinking agents are described by T. A. Misev in “Powder Coatings: Chemistry and Technology”, J. Wiley & Sons, Chichester on pages 123 and 124.

Polyacrylates, which commonly have hydroxyl, carboxyl or glycidyl functionality, are also employed as binders for powder coatings. They are prepared by the customary methods, principally from monomers such as, for example, styrene and linear or branched C₁-C₈alkyl esters of acrylic acid or methacrylic acid. Other ethylenically unsaturated compounds, for example divinylbenzene, acrylamide, methacrylamide, butoxymethylacrylamide, acrylonitrile, butadiene, etc., can also be added and copolymerized. Hydroxyl functionality is ensured by the copolymerization of hydroxy-functional monomers, for example hydroxyethyl acrylate, hydroxyethyl methacrylate, hydroxypropyl acrylate, hydroxypropyl methacrylate. For carboxyl functionality, ethylenically unsaturated acids and anhydrides are used, for example acrylic acid, methacrylic acid, itaconic acid, crotonic acid, maleic anhydride, itaconic anhydride, acrylic anhydride or methacrylic anhydride (U.S. Pat. No. 3,836,604). Glycidyl functionality is given, as taught in EP-A-0 256 369 and U.S. Pat. No. 3,876,578, by the copolymerization of monomers such as glycidyl acrylate and glycidyl methacrylate. As crosslinking agents for polyacrylates with hydroxyl or carboxyl functionality it is possible in principle to use the same compounds as already described for the polyesters with hydroxyl or carboxyl functionality. Further suitable crosslinking agents are the epoxy compounds of U.S. Pat. No. 0,045,040. Suitable crosslinking agents for polyacrylates with glycidyl functionality are dicarboxylic acids, for example sebacic acid, 1,12-dodecanedicarboxylic acids, and anhydrides, for example bistrimellitic anhydride, and the compounds described in U.S. Pat. No. 3,880,946. Furthermore, autocrosslinking polyacrylates from DE-A-3 310 545 are also known.

Epoxy resins for powder coatings are mostly either Novolac®-epoxy resins or, in particular, those based on aromatic polyols, especially those based on bisphenol such as bisphenol A. Also known are modified bisphenol-epoxy resins, from JP-A-58 187 464 (1982). The epoxy resins are employed in combination with crosslinkers from the classes of the solid aliphatic amines, solid aromatic amines, amine adducts, phenolic resins, polyacids and the carboxy-functional polyesters already described. Very particular mention as hardeners is to be made of the dicyandiamides, which are frequently employed together with a catalyst such as Lewis acids, boron trifluoride-amine complexes, metal complexes, tertiary or quaternary amines, and imidazoline derivatives, such as 2-methylimidazoline.

In the powder coating compositions according to the present invention the resin and the crosslinking agent are employed judiciously in approximately stoichiometric amounts. Deviation from the stoichiometric amounts by more than 30% leads in most cases to a decrease in the desired physical properties of the cured coating film, for example flexibility, impact strength, adhesion, weathering resistance or solvent resistance.

In addition to components (I), (II) and optionally (III) it is possible in the powder coating compositions according to this invention to include further additives as well.

Preferred powder coating compositions include, as further additives, one or more components from the group of the pigments, dyes, fillers, waxes, levelling assistants, degassing agents, charge control agents, optical brighteners, adhesion promoters, antioxidants, light stabilizers, curing catalysts or photoinitiators. The novel powder coating compositions may also include corrosion inhibitors, for example anticorrosion pigments, such as phosphate- or borate-containing pigments or metal oxide pigments, or other organic or inorganic corrosion inhibitors, for example salts of nitroisophthalic acid, phosphoric esters, technical-grade amines or substituted benzotriazoles.

Suitable photoinitiators for powder coating compositions which are cured, for example, with UV light are those based on benzophenones, phenylglyoxalates, bis- and/or mono-acyl-phosphine oxides, α-hydroxy ketones or benzil dimethyl ketals. As light sources it is judicious to employ medium-pressure or high-pressure mercury lamps.

Examples of degassing agents are fatty acid amides as described in EP-A-0 471 409, ε-caprolactam, methyl isophthalate and dimethyl isophthalate (EP-A-284 996) and, very particularly, benzoin.

Examples of levelling assistants are epoxidized fatty acids, abietyl alcohol, polylauryl methacrylate, polylauryl acrylate, polydimethylsiloxane-polyalkylene oxide block copolymers or, in particular, polymers and copolymers of low molecular weight of C₁-C₈alkyl acrylate esters or alkyl methacrylate esters.

Adhesion promoters are based, for example, on modified silanes, titanates or zirconates.

An example of an optical brightener is Uvitexo®OB (Ciba Specialty Chemicals).

The pigments are, for example, titanium dioxide, iron oxide, carbon black, aluminium bronze, phthalocyanine blue or aminoanthraquinone.

Examples of fillers are talc, alumina, aluminium silicate, aluminium phosphate, barytes, mica, lithopone, silica, calcium carbonate or magnesium carbonate, magnesium oxide, zinc oxide, zinc carbonate, zinc phosphate or mixtures thereof.

Particularly preferred powder coating compositions according to this invention comprise as further additives antioxidants, especially benzofuran-2-ones, examples of which are described in EP-A-857,765. These benzofuran-2-ones are usually added in an amount of about 0.01-10% based on the overall weight of the powder coating composition. A particularly preferred benzofuran-2-one is 5,7-di-tert-butyl-3-(3,4-dimethylphenyl)-benzofuran-2-one.

There are, however, applications in which additional heat stability in use is required, for example, as coatings on radiators, light fittings and domestic ovens etc. For this reason, the addition of other classes of antioxidants may therefore also be desirable. Examples of such compounds include the following:

1. Antioxidants

1.1. Alkylated monophenols, for example 2,6-di-tert-butyl-4-methylphenol, 2-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-di-methylphenol, 2,6-dioctadecyl-4-methylphenol, 2,4,6-tricyclohexylphenol, 2,6-di-tert-butyl-4-methoxymethylphenol, linear or branched nonylphenol, for example 2,6-di-nonyl-4-methyl-phenol, 2,4-dimethyl-6-(1′-methylundec-1′-yl)-phenol, 2,4-dimethyl-6-(1′-methylheptadec-1′-yl)-phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol.

1.3. Hydroquinones and alkylated hydroguinones, for example 2,6-di-tert-butyl-4-methoxy-phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. O-, N- and S-benzyl compounds, for example 3,5,3′,5′-tetra-tert-butyl-4,4′-dihydroxydibenzyl ether, octadecyl 4-hydroxy-3,5-dimethylbenzylmercaptoacetate, trideyl 4-hydroxy-3,5-di-tert-butylbenzylmercaptoacetate tris(3,5-di-tert-butyl-4-hydroxybenzyl)amine, bis(4-tert-butyl-3-hydroxy-2,6-dimethylbenzyl) dithioterephthalate, bis(3,5-di-tert-butyl-4-hydroxybenzyl) sulfide, isooctyl 3,5-di-tert-butyl-4-hydroxybenzylmercaptoacetate.

1.7. Hydroxybenzylated malonates, for example dioctadecyl 2,2-bis(3,5-di-tert-butyl-2-hydroxybenzyl)malonate, dioctadecyl 2-(3-tert-butyl-4-hydroxy-5-methylbenzyl)malonate, didodecyl mercaptoethyl-2,2-bis(3,5-di-tert-butyl-4-hydroxybenzyl)malonate, di-[4-(1,1,3,3-tetramethylbutyl)phenyl] 2,2-bis(3,5-di-tert-butyl-4-hydroxybenzyl)malonate.

1.8. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.9. Triazine compounds, for example 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurat, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl) isocyanurate.

1.10. Benzylphosphonates, for example dimethyl 2,5-di-tert-butyl-4-hydroxybenzyl-phosphonate, diethyl 3,5-di-tert-butyl-4-hydroxybenzylphosphonate, dioctadecyl 3,5-di-tert-butyl-4-hydroxybenzylphosphonate, dioctadecyl 5-tert-butyl-4-hydroxy-3-methylbenzylphosphonate, the calcium salt of the monoethyl ester of 3,5-di-tert-butyl-4-hydroxybenzylphosphonic acid.

1.11. Acylaminophenols, for example 4-hydroxylauranilide, 4-hydroxystearanilide, octyl N-(3,5-di-tert-butyl-4-hydroxyphenyl)carbamate.

1.12. Esters of D-(3.5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.13. Esters of D-(5-tert-butyl-4-hydroxy-3-methylphenyl)Dropionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of B-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)-oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis-(hydroxyethyl)-oxalamide, 3-thiaundecanol, 3-thiapentadecanol, trimethyihexanediol, trimethylolpropane, 4-hydroxymethyl-1-phospha-2,6,7-trioxabicyclo[2.2.2]octane.

1.16. Amides of β-(3,5-di-tert-butyl-4-hydroxyphenylpropionic acid e.g. N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

The phenolic antioxidants are added, for example, in concentrations of from 0.01 to 10%, based on the overall weight of the powder coating composition.

A further preferred embodiment of the present invention relates to a powder coating composition which additionally contains an antioxidant, in particular a benzofuran-2-one or a phenolic antioxidant.

In the preparation of the organic film-forming binder [component (I)] by polymerization or polycondensation of monomers, it is possible for components (II) and optionally (Ill) to be mixed in with the monomers even prior to polymerization.

Each of the components (II) and (III) may be used in an amount of from 0.001 to 5% by weight, for example from 0.01 to 5% by weight, preferably from 0.025 to 3% by weight, in particular from 0.05 to 3% by weight, based on the weight of component (I).

The weight ratio of components (II) to (III) is preferably from 2:1 to 1:20, in particular from 3:1 to 1:6, for example from 2:1 to 1:3.

The powder coating compositions are applied to the substrate in accordance with the customary techniques, especially electrostatic powder spraying. The powder sprayed out from the spray gun is electrostatically charged at a high-voltage electrode and is drawn to the workpiece under the action of the air flow and of the electrostatic force of attraction. The wraparound effect of the field lines ensures that undercuts and reverse sides too are coated. The applied particles, which adhere as a result of Coulomb forces, are melted together in an oven and cured. The preferred stoving temperatures are between 130 and 260° C., in particular between 140 and 220° C., depending on the reactivity of the film-forming binder (resin/hardener system) and on the oven construction. The stoving times are judiciously in a range from 2 to 30 minutes, the heat capacity of the substrate playing a large part. In the case of UV-curable systems, the powder coating composition—after the powder spraying operation—is melted, for example with infrared radiation, at a temperature of from 50 to 180° C. The coating is then exposed to UV light, preferably prior to cooling. In powder coil coating applications, short exposures to high temperatures in the range of 300-400° C. are used to cure the powder.

Preferred substrates are metallic substrates, for example iron, steel, copper, zinc, tin, magnesium, silicon, titanium or aluminium, and alloys thereof.

A preferred embodiment of the present invention is the use of component (II) as a stabilizer for reducing the discolouration of powder coating compositions which can be cured by heat, especially in gas ovens.

The present invention also provides a method of reducing the discolouration of heat-curable powder coating compositions containing an organic film-forming binder, which comprises incorporating in or applying to these compositions component (II) and optionally component (III) as defined above.

A preferred embodiment of the present invention also relates to the coating films applied and cured in accordance with the above methods.

The preparation of the powder coating compositions according to this invention can be accomplished by the customary methods. A good description of the operations and the machines is given in chapter 5 of T. A. Misev's book: “Powder Coatings: Chemistry and Technology”, J. Wiley & Sons, Chichester.

In general, all components of the powder coating composition are weighed out and mixed together in an appropriate mixer. This is done using tumble mixers, conical mixers, double-cone mixers, horizontal mixers, blenders and stirring apparatus such as planetary mixers.

The formulation is first of all processed in a heated extruder to give a highly homogeneous, melted composition. Apparatus suitable for this purpose comprises single-screw co-compounders, twin-screw extruders and planetary extruders. Metering is usually effected by means of a screw conveyor, a conveyor belt or a shaker trough at a temperature of 70-140° C., especially 80-110° C. Following extrusion the hot mass is rolled out and cooled, for example on a cooling belt. When it has solidifed, the mass is crushed and then ground. Suitable grinding units are pinned-disc mills, ultracentrifugal mills, jet mills and, especially, classifying mills. The powder is subsequently classified and preferably sieved. Prior to sieving it is also possible to add anticaking agents such as, for example, silica gel or alumina, or special-effect pigments, for example aluminium, bronze or mica.

The average particle size of the powder coating of the present invention is from 5 to 200 μm, in particular 10 to 100 μm, e.g. from 15 to 75 μm.

Other techniques for the preparation of powder coatings (EP-B-368851 or WO-A-92/00342) have recently been disclosed which can also be employed for this invention. In these techniques, the premixed formulation or extrudate is fed to a heated rotary tube and is spun out centrifugally on a rotary table. At the edge of the table, small, round, virtually monodisperse drops are formed which solidify in cooled air before falling to the floor.

A new process for preparing powder coating compositions consists in mixing components (I), (II) and optionally (III) in supercritical carbon dioxide and then removing the carbon dioxide by spray drying or evaporation (see U.S. Pat. No. 4,414,370 or U.S. Pat. No. 4,529,787). The stabilizers [components (II) and optionally (III)] are also extremely suitable for such processes for preparing powder coating compositions.

The powder coatings are applied by the methods customary in practice. It is possible, for example, to use corona guns and also triboelectric spray guns. Also employable are all variants of the fluidized sintering technique, with and without electrostatic charging. For thermoplastic powder coatings, flame spraying techniques can also be employed.

The stoving of the powder coating composition can, in addition to the gas ovens that are in the foreground of the present application, also be carried out by means of infrared heating or by electrical radiators.

In cases where one of components (II) and (III) is either a solid having a melting point of, for example, less than 50° C. or is a liquid at room temperature, problems may occur in handling because liquid or tacky components are difficult to mix together and to supply to an extruder. If one of components (II) and (III) is a solid having a melting point of, for example, more than 120° C., or the solid has a high melt viscosity, handling difficulties may likewise occur. In such cases it is useful that components (I) and optionally (III) can be employed in the form of a masterbatch.

A masterbatch is essentially a concentrate of components (II) and optionally (III) in dispersion or, preferably, in solution in a resin. The resin which forms component (I) is, for example a polyester resin, an epoxy resin or a polyacrylate resin. The amount of components (II) and optionally (III) that a masterbatch can comprise is determined only by the solubility and physical properties of the masterbatch, for example tendency towards caking. A masterbatch judiciously comprises components (II) and optionally (III) in an amount of from 5 to 90% by weight, in particular from 5 to 60% by weight, for example from 5 to 30% by weight, relative to the overall weight of the masterbatch.

A masterbatch can be prepared as early as during the preparation of the resins. Thus it is possible, for example, in the course of the preparation of polyesters which are prepared at about 240° C., to add components (II) and optionally (III) during the cooling operation. By adding components (II) and optionally (III) to the monomers prior to the condensation reaction, components (II) and optionally (III) are able to protect the resin against oxidation even during its preparation. Particular preference is given in this context to those components (II) and (III) which are chemically inert in the condensation reaction. The additional components of the powder coating, for example levelling assistants or devolatilizing agents, can also be incorporated into the masterbatch.

The present invention therefore also provides a masterbatch comprising a resin and the components (II) and optionally (III).

Components (II) and optionally (III) can also be applied to a carrier material. This is particularly expedient, for example, when components (II) and (III) are a liquid or a soft, tacky resin. The amount of carrier material used is judiciously only so much as to give a flowable and readily admixable powder. Components (II) and optionally (III) can be sprayed onto the carrier material with or without solvent. Preferred carrier materials are porous solids of low particle size with high oil absorption numbers. Particularly important examples are alumina or silica gel.

The examples which follow illustrate the invention further. Parts and percentages are by weight.

### EXAMPLE 1

To prepare the powder coating composition 570 g of polyester Grilesta®V77-10 (UCB Sa Belgium), 30 g of Primid® XL552 (Ems Chemie AG), 9 g of Resiflow® PV 5 (Worlée Chemie GmbH), 2.5 g of benzoin (Fluka AG), 300 g of titanium dioxide type 2160 (Kronos) and the amount of stabilizers indicated in Table 1 are mixed.

The components are mixed using a planetary stirrer. The mixture is then extruded on a Prism extruder at 300 revolutions/minute and at 100° C. and is rolled out (The melting temperature in the extruder is about 128° C). Subsequently, the powder coating composition is ground to an average particle size of about 40 μm in a Retsch ZM-1 ultracentrifugal mill. Finally, the powder is screened through a 125 μm screen on a centrifugal screening machine.

The finished powder coating composition is sprayed electrostatically onto white coil-coated aluminum panels using a Wagner Corona-Star gun at a voltage of 60 kV. After baking the coating thickness is about 90 μm. The colour is determined with a spectrophotometer according to DIN 6174 and b* is a measure for the yellowing. More positive values of b* denote greater yellowing. The results are summarized in Table 1.

TABLE 1

| | b* after | | |
|---|---|---|---|
| | | 20 min at | 20 min at |
| | | 190° C. and | 190° C. and |
| | 20 min at | 60 min at | 20 min at |
| Stabilizer | 190° C. | 190° C. | 230° C. |
| — | 3.1 | 4.8 | 7.8 |
| 1.14 g of Compound (A-1-b) | 2.4 | 3.7 | 5.0 |
| and | | | |
| 4.56 g of Compound (H) | | | |

Compound (A-1-b)

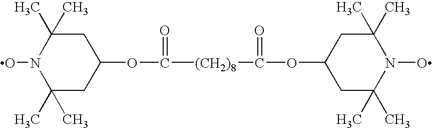

Compound (H)

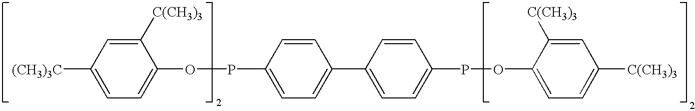

### EXAMPLE 2

White-pigmented polyester/epoxy powder coatings, the formulations of which are described in Table 2, are prepared analogously to EXAMPLE 1.

TABLE 2

| | Example no. . . . Amount in g . . . | | |
|---|---|---|---|
| Component | 2a | 2b | 2c |
| Crylcoat ® 360^{a)} | 578 | 578 | 578 |
| Araldit ® GT 7004^{b)} | 385 | 385 | 385 |
| Araldit ® DT 3126^{c)} | 25 | 25 | 25 |
| Kronos ® 2160 (TiO₂) | 500 | 500 | 500 |
| ResifIow ® PV88^{d)} | 10 | 10 | 10 |
| Benzoin | 2 | 2 | 2 |
| Compound D | — | 3.08 | 3.08 |
| Compound (A-1-b) | — | 1.54 | — |
| Compound (A-1-a) | — | — | 1.54 |

^{a)}Crylcoat ® 360 is a carboxy-functional polyester resin from UCB Chemicals, Drogenbos.
^{b)}Araldit ® GT 7004 is a bis-phenol A epoxy resin from Vantico AG, Basel.
^{c)}Araldit ® DT 3126 a catalyst masterbatch, from Vantico AG, Basel.
^{d)}Resiflow ® PV88 is an acrylate copolymer flow aid from Worlée Chemie GmbH, Lauenburg, Deutschland

Compound D:

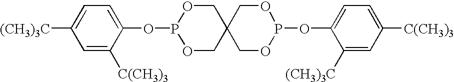

Compound (A-1-a):

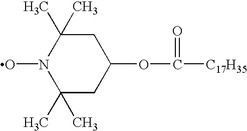

Compound (A-1-b):

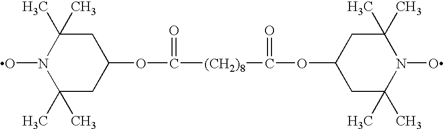

The powder coatings are sprayed onto white coil-coated aluminum panels to a thickness of 80-90 μm. The panels are cured in an electric oven with the air exhaust set to a minimum at 190° C. for 20 minutes. A mixture of 1 g sodium nitrite plus 1 g glacial acetic acid in a petri dish is placed inside the hot oven together with the panels, as a convenient source of nitrogen oxides. After 20 minutes in the oven the panels are removed and the CIELAB colour measured according to DIN 6174. More positive values of b* denote greater yellowing. The results are shown in Table 3.

TABLE 3

| Example | Yellowness as b* |
|---|---|
| 2a | 2.98 |
| 2b | 1.69 |
| 2c | 1.35 |

1. A powder coating composition comprising
(I) an organic film-forming binder and
(II) a sterically hindered amine compound selected from the group consisting of the classes (a-1) to (a-11) and (b-i) to (b-4);
(a-1) A Compound of the Formula (A-1) 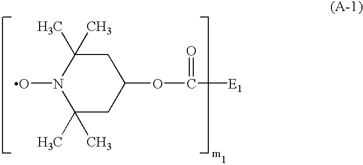
in which
m₁ is 1, 2 or 4,
if m, is 1, E₁ is C₁-C₂₅alkyl,
if ml is 2, E₁ is C₁-C₁₄alkylene, and
if ml is 4, E₁ is C₄-C₁₀alkanetetrayl;
(a-2) A Compound of the Formula (A-2) 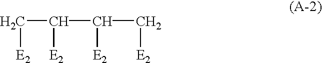
in which
two of the radicals E₂ are —COO—(C₁-C₂₀alkyl), and
two of the radicals E₂ are a group of the formula (a-I); 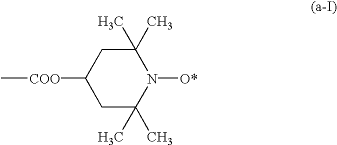
(a-3) A Compound of the Formula (A-3) 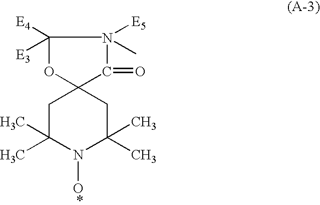
in which
E₃ and E₄ together form C₂-C₁₄alkylene,
E₅ is hydrogen or a group -Z₁-COO-Z₂,
Z₁ is C₂-C₁₄alkylene, and
Z₂ is C₁-C₂₄alkyl;
(a-4) A Compound of the Formula (A-4) 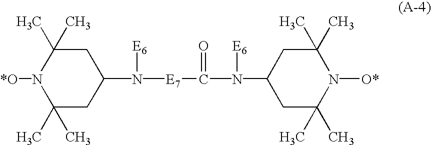
wherein
the radicals E₆ independently of one another are hydrogen or C₁-C₁₂alkyl, and
E₇ is C₁-C₁₀alkylene or C₃-C₁₀alkylidene;
(a-5) The Compound of the Formula (A-5) 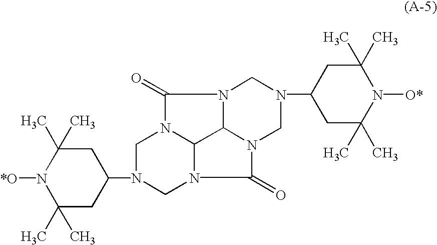
(a-6) A Compound of the Formula (A-6) 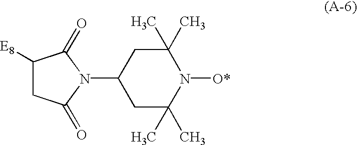
in which
E₈ is C₁-C₂₄alkyl;
(a-7) The Compound of the Formula (A-7) 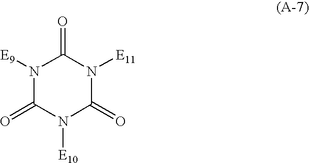
in which
E₉, E₁₀, and E₁₁ are a group of the formula (a-II); 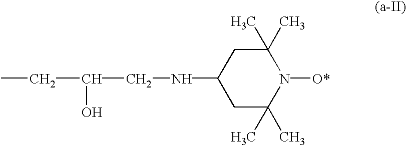
(a-8) A Compound of the Formula (A-8) 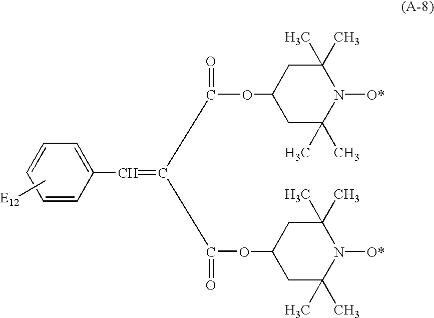
wherein
E₁₂ is hydrogen, C₁-C₁₂alkyl or C₁-C₁₂alkoxy;
(a-9) A Compound of the Formula (A-9) 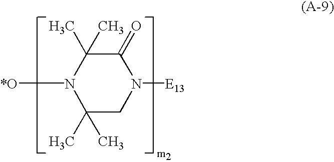
wherein
m₂ is 1 or 2, and
when m₂ is 1, E₁₃ is a group 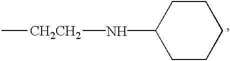
and
when m₂ is 2, E₁₃ is C₂-C₂₂alkylene; and
(a-10) A Compound of the Formula (A-10) 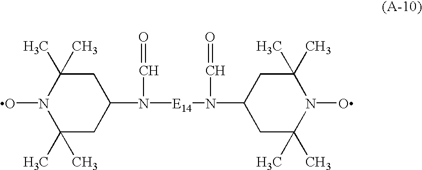
wherein
E₁₄ is C₂-C₂₂alkylene, C₅-C₇cycloalkylene, C₁-C₄alkylenedi(C₅-C₇cycloalkylene), phenylene or phenylenedi(C₁-C₄alkylene);
(a-11) The Compound of the Formula (A-11); 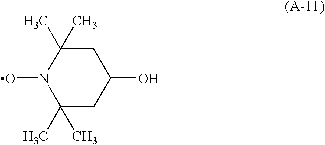
(b-1) A Compound of the Formula (B-1) 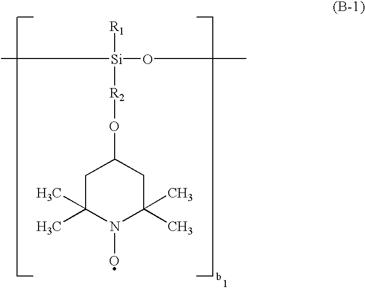
in which
R₁ is C₁-C₁alkyl, C₅-C₁₂cycloalkyl, C₁-C₄alkyl-substituted C₅-C₁₂cycloalkyl, phenyl or
C₁-C₁₀ alkyl-substituted phenyl,
R₂ is C₃-C₁₀alkylene, and
b₁ is a number from 2 to 50;
(b-2) A Compound of the Formula (B-2) 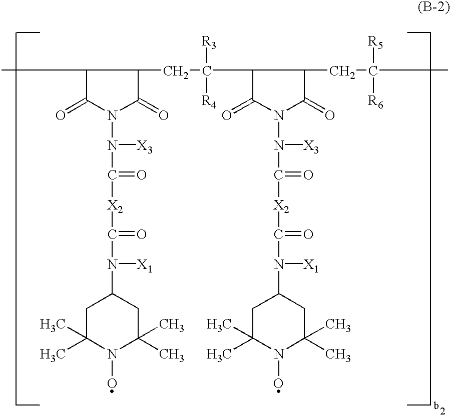
in which
X₁ and X₃ independently of one another are hydrogen, C₁-C₈alkyl, C₅-C₁₂cycloalkyl, phenyl, C₇-C₉phenylalkyl or a group of the formula (b-I), 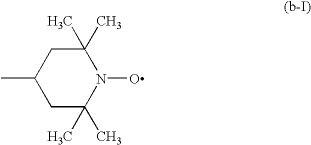
X₂ is a direct bond or C₁-C₄alkylene,
R₃, R₄, R₅ and R₆ independently of one another are hydrogen, C₁-C₃₀alkyl, C₅-C₁₂cycloalkyl
or phenyl, and
b₂ is a number from 1 to 50;
(b-3) A Compound of the Formula (B-3) 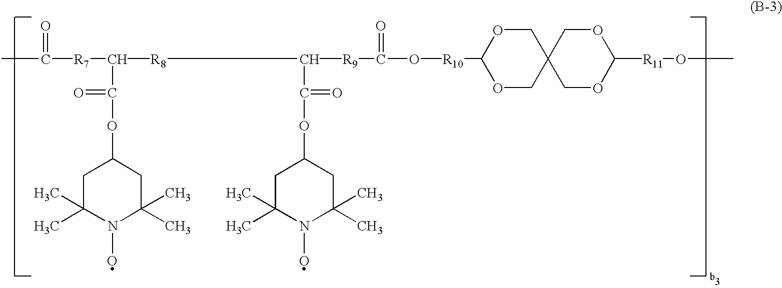
in which
R₇, R₈, R₉, R₁₀ and R₁₁ independently of one another are a direct bond or
C₁-C₁₀alkylene, and
b₃ is a number from 1 to 50;
(b-4) A Compound of the Formula (B-4) 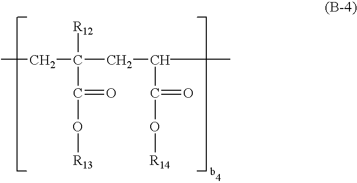
wherein b₄ is a number from 2 to 50,
R₁₂ is hydrogen or Cl-C₄alkyl,
the radicals R13 and R14 independently of one another are C₁-C₄alkyl or a group of the formula (b-I),
with the proviso that at least 50% of the radicals R₁₄ are a group of the formula (b-I).

2. A powder coating composition according to claim 1, wherein m₁ is different from 2.

3. A powder coating composition according to claim 1, which is a heat curable powder coating composition.

4. A powder coating composition according to claim 1, which is a gas oven curable powder coating composition.

5. A powder coating composition according to claim 1, wherein
m₁ is 1, 2 or 4,
if m₁ is 1, E₁ is C₁₂-C₂₀alkyl,
if m₁ is 2, E₁ is C₂-C₁₀alkylene, and
if m₁ is 4, E₁ is C₄-C₈alkanetetrayl;
two of the radicals E₂ are —COO—(C₁₀-C₁₅alkyl), and
two of the radicals E₂ are a group of the formula (a-I);
E₃ and E₄ together form C₉-C₁₃alkylene,
E₅ is hydrogen or a group -Z₁-COO-Z₂,
Z₁ is C₂-C₆alkylene, and
Z₂ is C₁₀-C₁₆alkyl;
E₆ is hydrogen, and
E₇ is C₂-C₆alkylene or C₃-C₅alkylidene;
E₈ is C₁₀-C₁₄alkyl;
E₁₂ is C₁-C₄alkoxy;
m₂ is 1 or 2,
when m₂ is 1, E₁₃ is a group 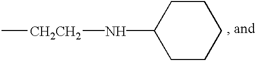
, and
when m₂ is 2, E₁₃ is C₂-C₆alkylene;
E₁₄ is C₂-C₈alkylene;
R₁ is C₁-C₄alkyl,
R₂ is C₃-C₆alkylene, and
b₁ is a number from 2 to 25;
X₁ and X₃ independently of one another are hydrogen or C₁-C₄alkyl,
X₂ is a direct bond,
R₃ and R₅ are hydrogen or C₁-C₄alkyl,
R₄ and R₆ are C₁-C₂₅alkyl,
b₂ is a number from 1 to 25;
R₇, R8, R₉, R₁₀ and R₁₁ independently of one another are a direct bond or
C₁-C₄alkylene, and
b₃ is a number from 1 to 25;
b₄ is a number from 2 to 25,
R₁₂ and R₁₃ independently of one another are C₁-C₄alkyl, and
R₁₄ is C₁-C₄alkyl or a group of the formula (b-I)
with the proviso that at least 50% of the radicals R₁₄ are a group of the formula (b-I).

6. A powder coating composition according to claim 1, wherein the sterically hindered amine compound of component (II) is a compound of the formula (A-1-a), (A-1-b), (A-1-c), (A-2-a), (A-3-a), (A-3-b), (A-4-a), (A-4-b), (A-5), (A-6-a), (A-7), (A-8-a), (A-9-a), (A-9-b), (A-10-a), (A-11), (B-1-a), (B-2-a), (B-3-a) or (B-4-a); 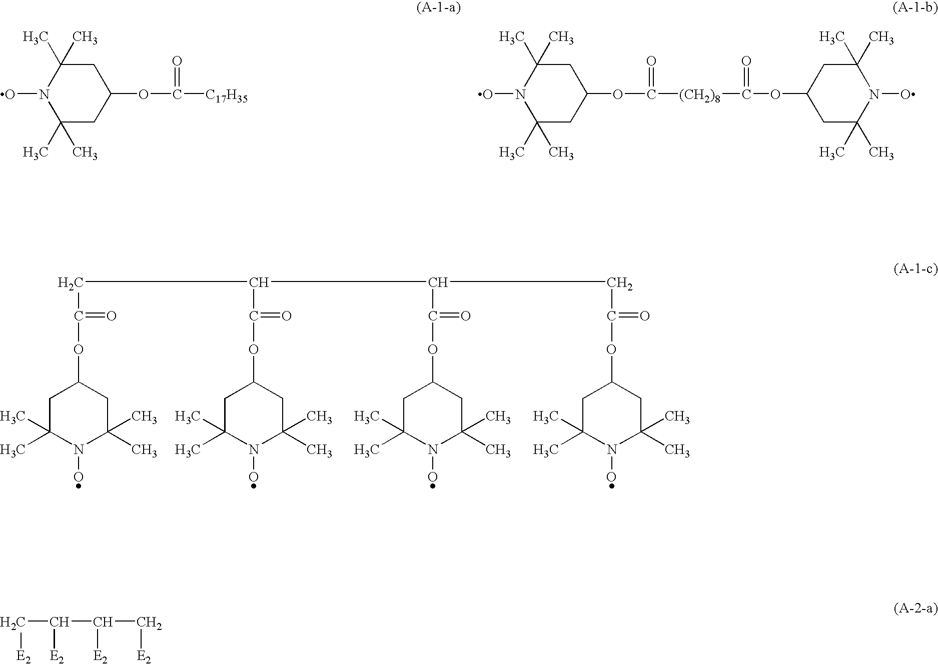
in which two of the radicals E₂ are —COO—C₁₃H₂₇ and
two of the radicals E₂ are 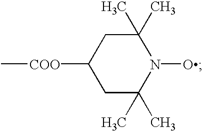 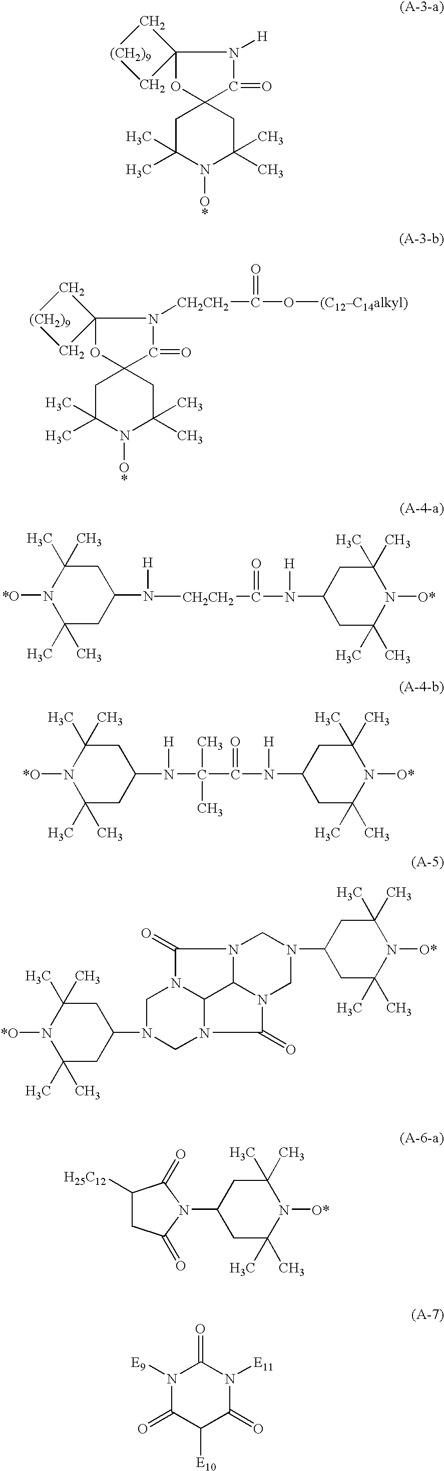
in which E₉, E₁₀ and E₁₁ independently of one another are a group of the formula (a-II) 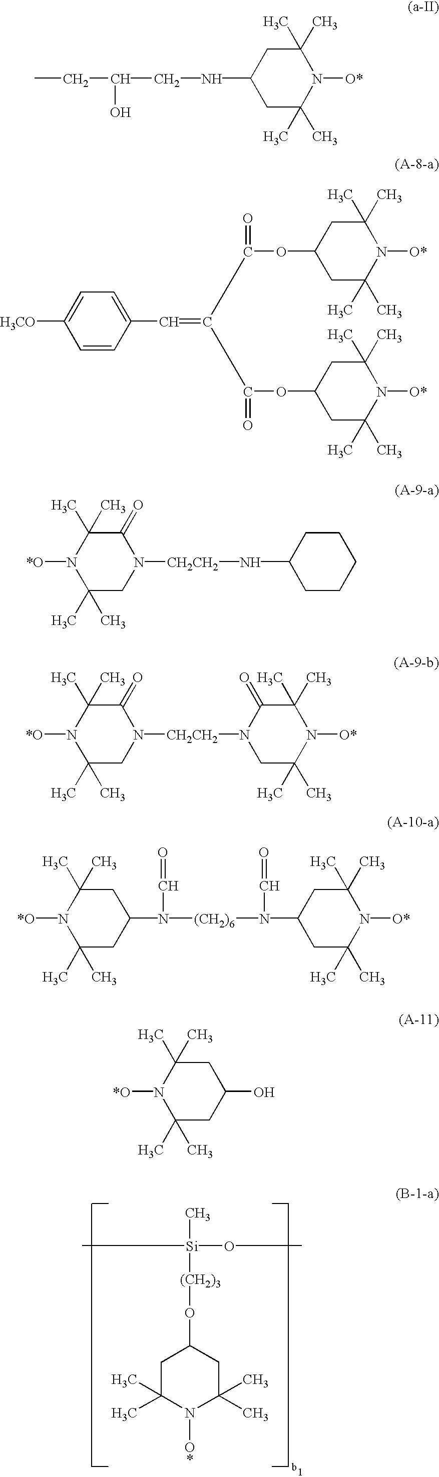
where in b₁ is a number from 1 to 20; 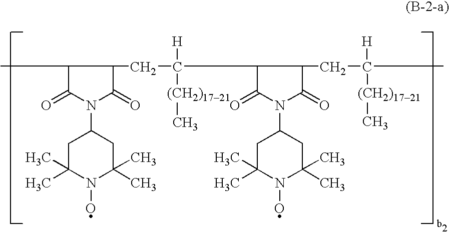
wherein b₂ is a number from 1 to 20; 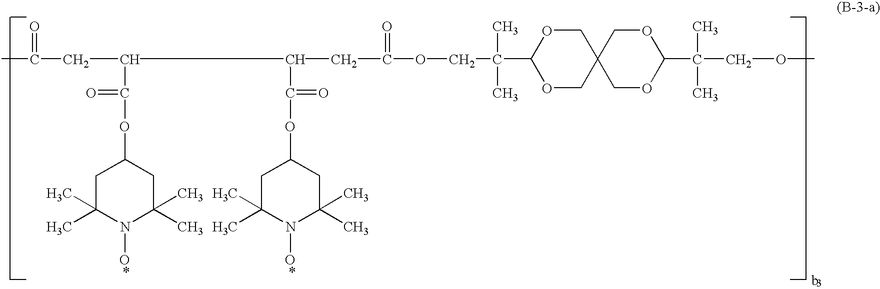
wherein b₃ is a number from 1 to 20; 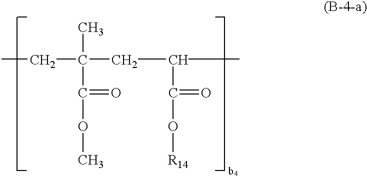
wherein b₄ is a number from 2 to 20, and
at least 50% of the radicals R₁₄ are a group of the formula (b-I) 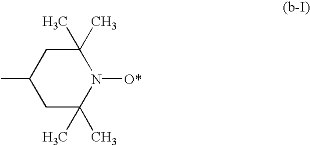
and the remaining radicals R₁₄ are ethyl.

7. A powder coating composition according to claim 1, wherein the sterically hindered amine compound of component (II) is selected from the group consisting of the classes (a-1) to (a-4), (a-6) to (a-10), (b-1), (b-3) and (b-4).

8. A powder coating composition according to claim 1, wherein the sterically hindered amine compound of component (II) is selected from the group consisting of the classes (a-1), (a-2) and (a-10).

9. A powder coating composition according to claim 1, wherein the sterically hindered amine compound of component (II) is selected from the group consisting of the classes (a-1) and (a-2).

10. A powder coating composition according to claim 6, in which the sterically hindered amine compound of component (II) is a compound of the formula (A-1-a) or (A-1-b).

11. A powder coating composition according to claim 1, which additionally contains
(III) an organic phosphite or an organic phosphonite.

12. A powder coating composition according to claim 11, wherein component (III) is a compound of the formula (1), (2), (3), (4), (5), (6) or (7); 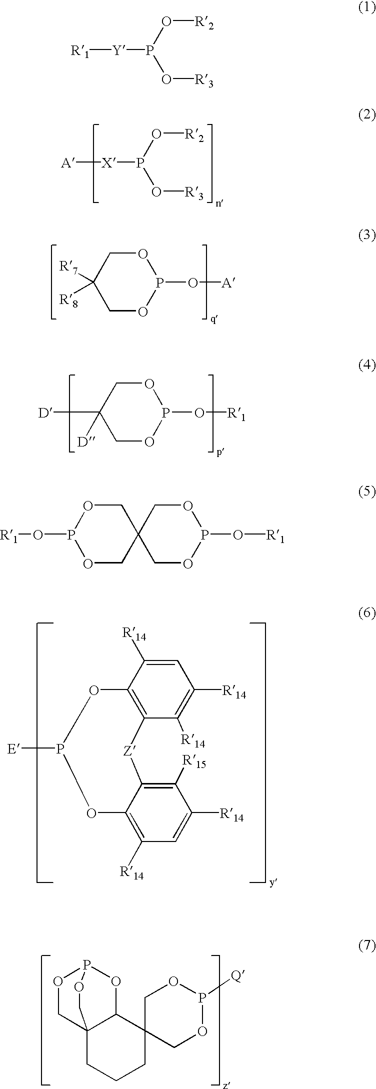
in which the indices are integers and
n′ is 2, 3 or 4; p′ is 1 or 2; q′ is 2 or 3; r′ is 4 to 12; y′ is 1, 2 or 3; and z′ is 1 to 6;

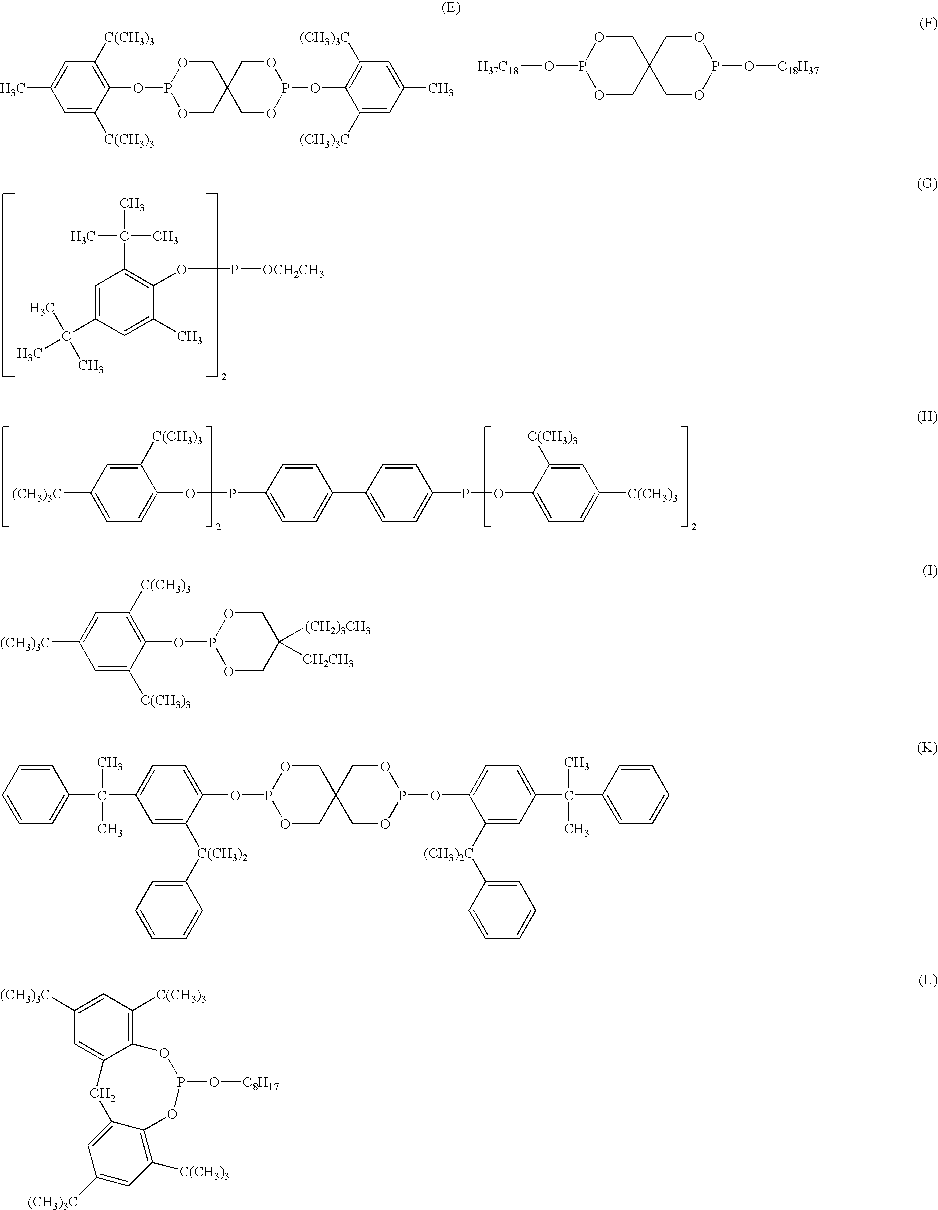

14. A powder coating composition according to claim 1, which additionally contains a benzofuran-2-one and/or a phenolic antioxidant.

15. A powder coating composition according to claim 1, in which component (I) is an epoxy resin, a polyester-hydroxyalkylamide, a polyester-glycoluril, an epoxy-polyester resin, a polyester-triglycidyl isocyanurate, a hydroxy-functional polyester-blocked polyisocyanate, a hydroxy-functional polyester-uretdione, an acrylate resin with hardener or a mixture of such resins.

16. A method of reducing the discolouration of heat-curable powder coating compositions containing an organic film-forming binder, which comprises incorporating in or applying to these compositions a sterically hindered amine compound as defined in claim 1 as component (II).

17. A method of curing powder coating compositions containing the components (I) and (II) as defined in claim 1, which comprises curing in a gas oven wherein the powder coating composition is in contact with oxides of nitrogen originating from combustion gases.
